(19) United States
(12) Patent Application Publication
(10) Pub. No.: US 2003/0234247 A1
(43) Pub. Date: Dec. 25, 2003

(54) Methods and apparatus for a multi-zone blanket

(76) Inventor: Lessing S. Stern, Scottsdale, AZ (US)

Correspondence Address: Daniel R. Pote, Esq., SNELL & WILMER LLP, One Arizona Center, 400 East Van Buren, Phoenix, AZ, 85004-2202, US

(21) Appl. No.: 10/174,608

(22) Filed: Jun. 19, 2002

(51) Int. Cl. H05B 1/02; H05B 3/00

(52) U.S. Cl. 219/491; 219/494; 219/212; 5/421; 5/486

(57) ABSTRACT

A multi-zone bedding system includes a blanket (or sleeping bag, pad, medical heating enclosure, or the like) defined by two or more zones having independent insulation values. In one embodiment, the bedding system includes a controller configured to independently modify or regulate the insulation value of one or more of those zones to suit the personal preferences of the individual or individuals using the system. The insulation value of the zones may be altered by modifying, for example, the density, material type, air content, internal chemical reaction, electrical current, and/or the thickness of the blanket.

### BACKGROUND OF THE INVENTION

1. Technical Field

This invention relates, generally, to bedding systems and, more particularly to an improved blanket with multiple zones with adjustable insulation properties.

2. Background Information

Traditional bedding systems typically include a top blanket, comforter or the like on top of the bed for providing the primary source of insulation against the environment, A particular individual will generally select a blanket type which fits his or her personal preferences, based on, for example, room temperature and preferred sleeping temperature—both of which may vary with season, time, bed-clothes, and other such variables.

Given the individualized nature of blanket preferences, it is not surprising that two individuals using a single blanket will find it difficult if not impossible to select a blanket which simultaneously conforms to their individual preferences. Simply stated, if one person is comfortable, the other is invariably too hot or too cold.

Known bedding systems are unsatisfactory in a number of respects. For example, while blankets have been developed which have multiple thicknesses for different regions of the blanket, the insulation value of each region is constant, and may not precisely fit the preferences of the user. And while other known systems may modify the temperature of various regions of a blanket, those systems generally do so by using a series of electrical wires (i.e., an electric blanket) which changes the absolute temperature of the blanket but which does not directly impact the insulation value itself.

Known systems are also unsatisfactory in that they generally provide open-loop configurations; i.e., they do not provide meaningful feedback to keep the individual comfortable over time. Even in systems which provide rudimentary closed-loop regulation, this regulation is not based on temperature feedback from the blanket itself.

Accordingly, there is a need for an adjustable-insulation blanket which overcomes these and other limitations of the prior art.

### BRIEF SUMMARY OF THE INVENTION

The present invention overcomes shortcomings in the prior art by providing a multi-zone bedding system which includes a blanket (or sleeping bag, pad, medical heating enclosure, or the like) defined by two or more zones having independent insulation values. In one embodiment, the bedding system includes a controller configured to independently modify or regulate the insulation value of one or more of those zones to suit the personal preferences of the individual or individuals using the system. The insulation value of the zones may be altered by modifying, for example, the density, material type, air content, and/or the thickness of the blanket.

In accordance with a further embodiment of the present invention, the bedding system includes one or more sensors incorporated into the blanket for sensing and controlling the respective temperatures of the zones.

In accordance with a further embodiment of the present invention, an external sensor is coupled to the controller for sensing an attribute of the environment, i.e.: ambient light, ambient temperature, and the like.

In accordance with a further embodiment of the present invention, the controller includes a programmable timer and is configured to modify the insulation values of the blanket zones in response to one or more timed events.

In accordance with a further embodiment of the present invention, the blanket includes a transition zone between two of the zones, wherein the transition zone is configured to provide a transition insulation value between zones to compensate for the heating effect of two individuals located close to the center of the blanket.

In accordance with one aspect of the present invention, the blanket includes an inner chamber and the controller is configured to modify the first insulation value of at least one of the zones by controlling the volume of air within the inner chamber through, for example, the use of an air pump.

In accordance with another aspect of the present invention, the blanket includes an internal cellular structure whose thermal conductivity is a function of the volume of air contained within the cellular structure.

In accordance with a further embodiment of the present invention, the thickness of the zones is substantially constant across the various zones and/or the blanket is contained within an outer cover.

In accordance with a further embodiment of the present invention, the controller includes a memory configured to retain personal preferences and/or presets corresponding to, for example, the desired insulation values for the various zones.

In accordance with another embodiment of the present invention, the controller is configured to learn a set of preferences corresponding to a set of desired insulation values based on an individual's operation of the controller.

In accordance with yet another embodiment of the present invention, the insulation value and/or heat supplied by the blanket is a function of a chemical reaction (e.g., a chemical reaction modulated by an electrical excitation) produced within one or more zones of the blanket.

In accordance with yet another embodiment of the present invention, a blanket includes three or more zones whose respective temperatures are controlled through an applied electrical current (e.g., through heating wires, pads, or the like).

### BRIEF DESCRIPTION OF THE DRAWINGS

The subject invention will hereinafter be described in conjunction with the appended drawing figures, wherein like numerals denote like elements, and:

FIG. 1 is a conceptual overview of a bedding system in accordance with one embodiment of the present invention;

FIG. 2 is a conceptual overview of a bedding system including a controller configured to control two zones;

FIG. 3 is a conceptual overview of a bedding system including a sensor incorporated into one zone for providing feedback to the controller;

FIG. 4 is a conceptual overview of a bedding system including a second sensor incorporated into a second zone for providing feedback to the controller;

FIG. 5 is a conceptual overview of a bedding system further including one or more external sensors for sensing an attribute of the environment;

FIGS. 6A-6D present various zone configurations for a blanket in accordance with the present invention;

FIGS. 7A-7B are side-view conceptual overviews of a dual-zone blanket in accordance with one embodiment of the present invention;

FIGS. 8A and 8B are side-view conceptual overviews of a blanket in accordance with the present invention enclosed by a cover or sleeve; and

FIG. 9 shows a schematic diagram of a controller in accordance with one embodiment of the present invention.

### DETAILED DESCRIPTION

The present invention overcomes shortcomings in the prior art by providing a multi-zone bedding system including a blanket defined by two or more zones and a controller configured to independently modify the insulation value of one or more of those zones to suit the personal preferences of individuals using the system. The insulation value of the zones may be altered by modifying, for example, the density, material type, air content, and/or the thickness of the blanket.

In accordance with one embodiment of the present invention, a blanket is defined by two or more zones with independent insulation values. More particularly, referring momentarily to the exemplary cross-section shown in FIG. 10, a static blanket design 1000 may incorporate two or more zones (e.g., zones 1002 and 1004), wherein the thermal insulation value of zone 1002 (R_{th,1}) is different from and independent of the thermal insulation value of zone 1004 (R_{th,2}), wherein the thickness of the blanket is substantially constant across the regions. The insulation values for the various regions may be specified by altering one or more attributes of the blanket zones. For example, zone 1002 may comprise a different material from zone 1002. Alternatively, zone 1002 may comprise the same material as zone 1004, but may have a different density. In a further embodiment, zones 1002 and 1004 may include a structure, such as a cellular structure, that increases and decreases in insulation value when air or another gas is provided within the structure.

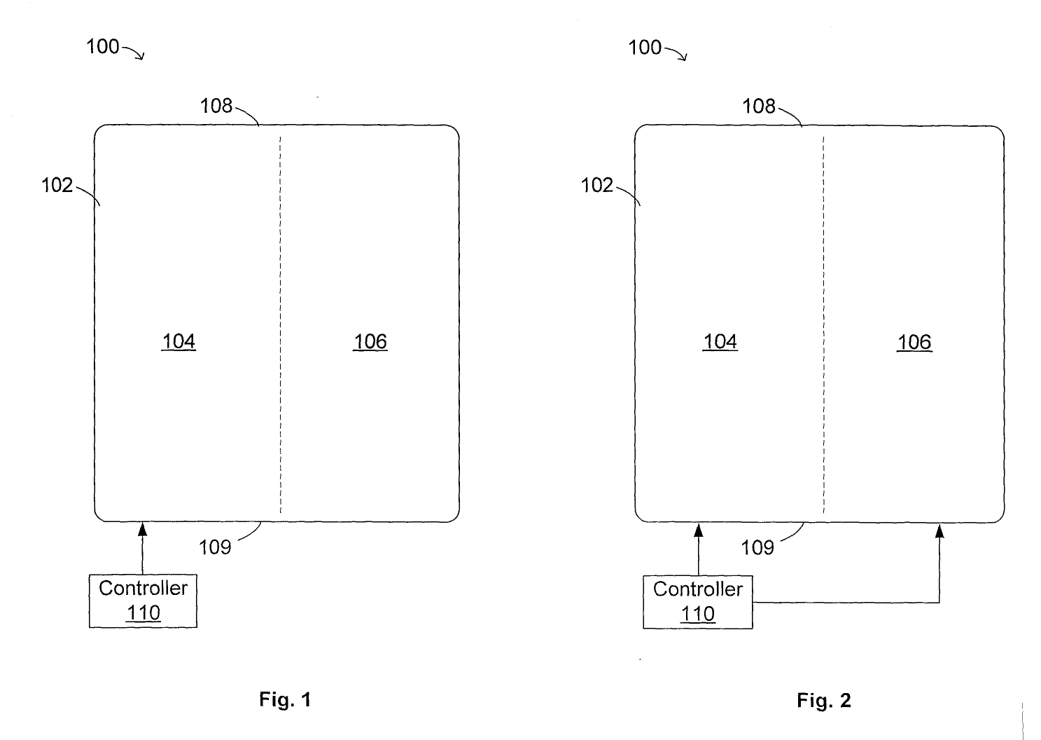

Referring now to FIG. 1, a bedding system 100 in accordance with another embodiment of the present invention comprises a blanket 102 partitioned into or otherwise defined by a first zone 104 and a second zone 106. Blanket 102 has a first end 109 (alternatively referred to as the “head” end), and a second end 108 (alternatively referred to as the “foot” end). A controller 110 is suitably coupled to first zone 104 and is configured to adjust the insulation value of first zone 104 in a manner which is substantially independent of the insulation value of zone 106. In an alternate embodiment, shown in FIG. 2, controller 110 is further configured to adjust the insulation value of second zone 106.

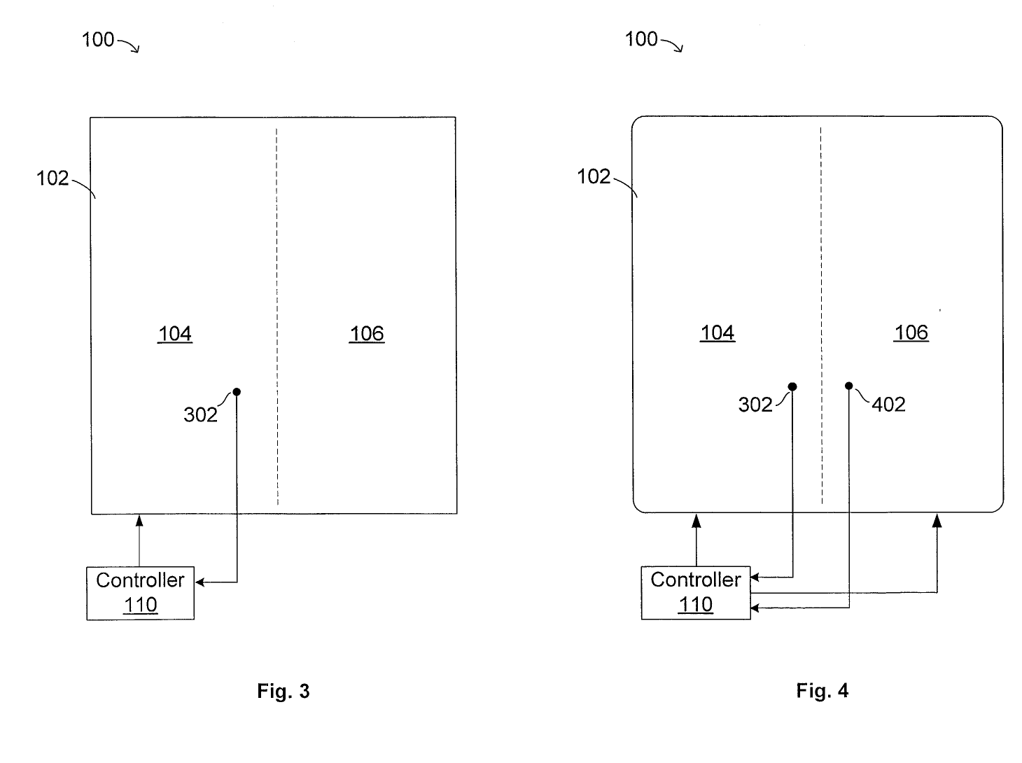

In accordance with a further embodiment of the present invention, the bedding system includes one or more sensors incorporated into the blanket for sensing and controlling the respective temperatures of the zones in a close-loop fashion. More particularly, referring now to FIG. 3, bedding system 100 includes a sensor 302 (e.g., a thermocouple or the like) which is suitably positioned and provided within, on, or under blanket 102 in region 104 to sense a temperature associated with region 104, e.g., the temperature of the interior of blanket 102, the temperature of a surface of blanket 102, or the temperature of an individual lying beneath blanket 102. FIG. 4 shows an alternate embodiment of the present invention wherein a second sensor 402 is incorporated into region 106 of blanket 102 and coupled to controller 110 to facilitate thermal control of region 106.

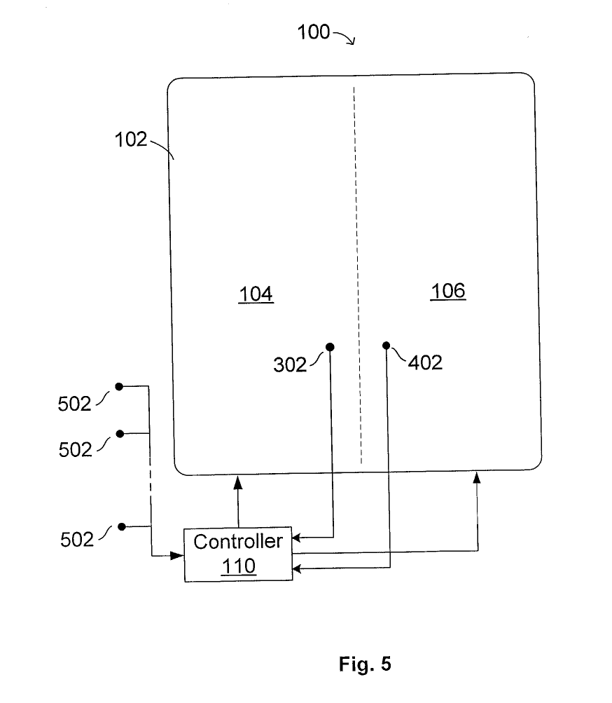

In accordance with a further embodiment of the present invention, an external sensor is coupled to the controller for sensing an attribute of the environment, i.e.: ambient light, ambient temperature, and the like. That is, with reference to FIG. 5, one or more external sensors 502 are coupled to controller 110 (or integrated into controller 110) and suitably positioned within the environment (e.g., bedroom, tent, etc.). Responsive to information received from sensor or sensors 502, controller 110 suitably adjusts a temperature associated with zone 104 and/or zone 106 of blanket 102.

In accordance with a further embodiment of the present invention, the blanket includes a transition zone between two of the zones, wherein the transition zone is configured to provide a transition insulation value between zones to compensate for the heating effect of two individuals located close to the center of the blanket.

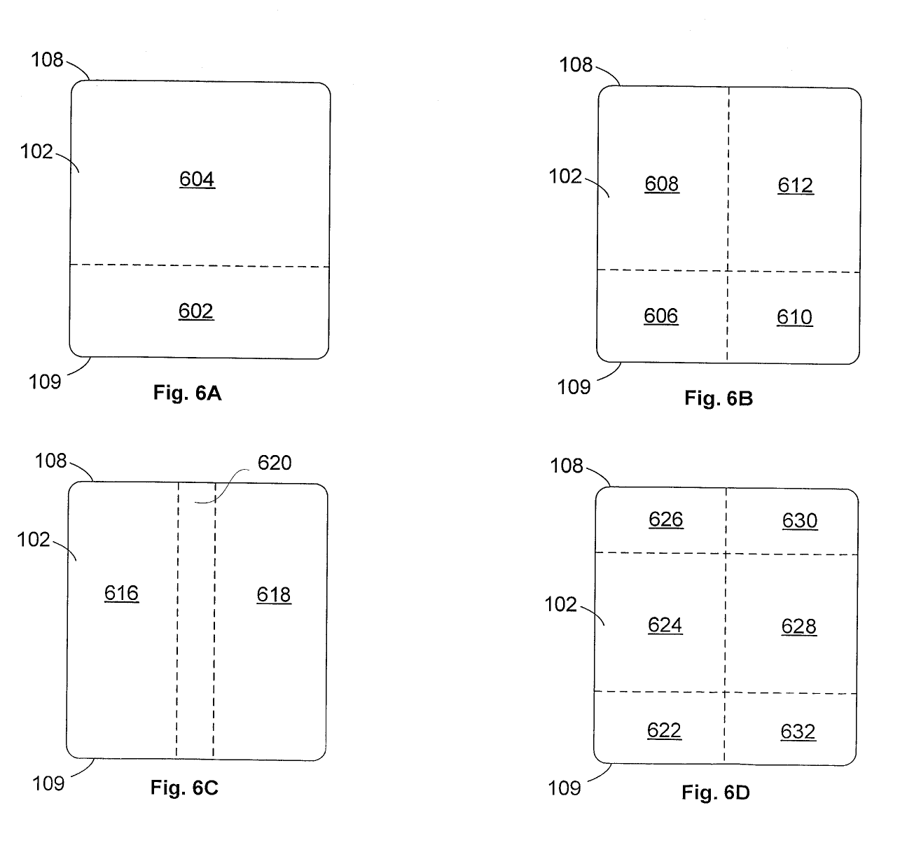

Blanket 102 may be partitioned into any number of zones to individually control the temperature of the zones in accordance with the desired goal. FIGS. 6A-6D depict exemplary multi-zone blanket configurations desirable in instances where one or more individuals are sleeping beneath the blanket.

FIG. 6A shows a configuration wherein two adjacent rectangular zones 602 and 604 are defined at approximately the head 109 and foot 108 of blanket 102 respectively. Such a configuration might be appropriate, for example, when it is desired that the foot of the blanket be hotter or colder than the blanket at the head of the bed.

FIG. 6B depicts a configuration wherein blanket 102 is partitioned into four generally rectangular zones 606, 608, 610, and 612. This variation is similar to FIG. 6A, but allows for individual side-by-side control of individual head and foot regions. That is, zones 608 and 606 generally correspond to the foot and head end of one individual sleeping under (or on) blanket 102, and zones 610 and 612 correspond to the food and head ends of another individual.

In accordance with another embodiment of the present invention blanket 102 is generally split into two primary zones 616 and 618 and one intermediary or transition zone 620 which compensates for the extra heating effects resulting from the proximity of two individuals near the center of blanket 102.

FIG. 6D depicts another example wherein blanket 102 is split into six zones. Zones 622, 624, and 626 generally corresponding to one individual, and zones 630, 628, and 632 corresponding to another individual.

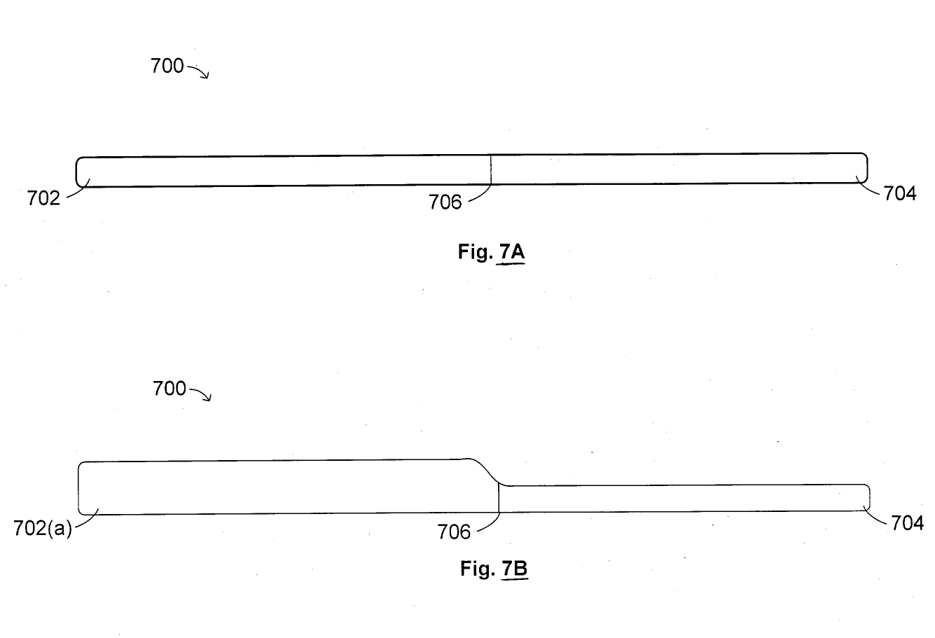

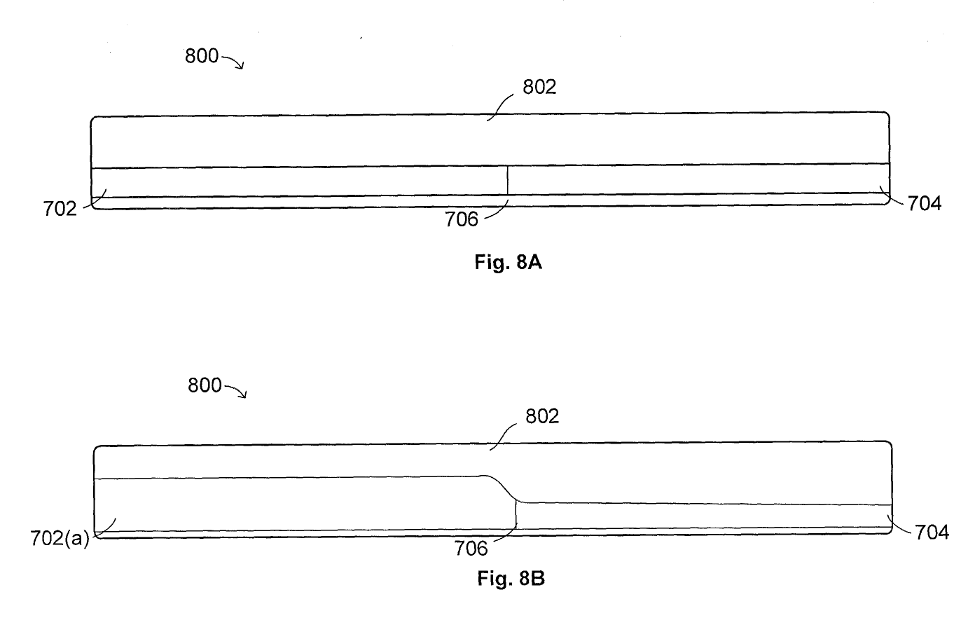

In accordance with one aspect of the present invention, the blanket includes an inner chamber and the controller is configured to modify the first insulation value of at least one of the zones by controlling the volume of air within the inner chamber through, for example, the use of an air pump. Referring to the cross-sectional overview shown in FIGS. 7 and 7A, a first inner chamber 702 is separate from a second inner chamber 704 by a partition, membrane, or other separator 706.

In accordance with another aspect of the present invention, the blanket includes an internal cellular structure whose thermal conductivity is a function of the volume of air contained within the cellular structure.

In accordance with a further embodiment of the present invention, the thickness of the zones is substantially constant across the various zones and/or the blanket is contained within an outer cover.

In accordance with a further embodiment of the present invention, the controller includes a memory configured to retain personal preferences and/or presets corresponding to, for example, the desired insulation values for the various zones.

In accordance with a further embodiment of the present invention, the controller includes a programmable timer and is configured to modify the insulation values of the blanket zones in response to one or more timed events.

In accordance with yet another embodiment of the present invention, the controller is configured to learn a set of preferences corresponding to a set of desired insulation values based on an individual's operation of the controller.

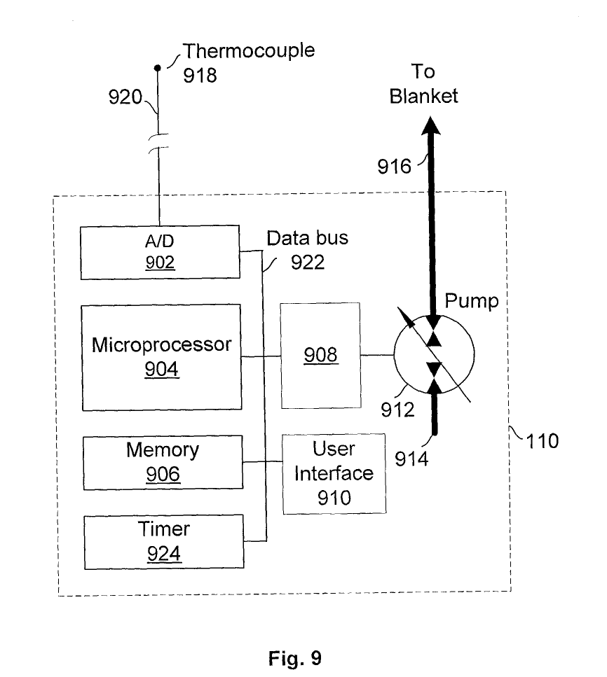

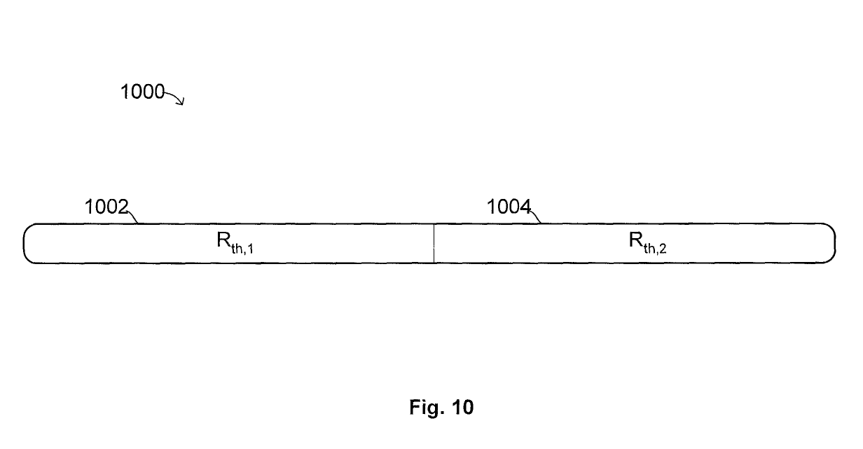

A controller in accordance with one embodiment of the present invention includes a pump, compressor, or other form of air supply controlled via a microprocessor and associated electronics, including a user interface which allows individuals to modify the characteristics of the blanket as desired. Referring to FIG. 9, for example, an exemplary controller 110 includes a microprocessor 904, a memory 906, a user interface 910, and a pump control block 908 communicating over a data bus 922. A pump or compressor 912 having an output 916 and vent 914 is suitably coupled to pump control block 908. In addition, a thermocouple 918 (which senses the temperature of the blanket or environment, as described above) may be coupled to an analog-to-digital converter (A/D) 902 via a wire 920, wherein A/D also communicates with microprocessor 904 and/or other components over data bus 922.

Pump 912 comprises any suitable uni-directional or bi-directional compressor, pump, or air supplier sufficient to effect insulation changes in the blanket to which it is coupled. Pump output 916 is suitably coupled to the blanket (not shown) via tubing, for example a small diameter flexible plastic tubing.

Pump control block 908 comprises any combination of analog and/or digital components (e.g., relays, passive components, transistors, and the like) appropriately configured to control the volume and/or pressure of air (or other gas) output from pump 912 in response to control signals from microprocessor 904.

A/D 902 functions to take the small voltage produced via thermocouple 918 (e.g., a standard JK thermocouple) and produce a suitable digital value for processing by microprocessor 904. In this regard, it will be appreciated that A/D 902 might also include certain amplification components configured to modify the range and sensitivity of the system with respect to thermal changes.

Microprocessor 904 suitably comprises any of a variety of standard microprocessors, microcontrollers, digital signal processors, application-specific integrated circuits (ASICs) and the like configured to control pump 912 to achieve the objectives described above. In accordance with one aspect of the present invention, microprocessor 904 includes thermostat functionality which processes thermal information regarding the various blanket zones and activates the pump to modify the insulation value of the blanket zones accordingly.

Memory 906 comprises any suitable form of memory (RAM, ROM, EEPROM, etc.) capable of storing user preferences, set-points for the various blanket zones, and any other data required by the system. In an alternate embodiment of the present invention, memory 906 is incorporated into microprocessor 904 (e.g., as on-board EEPROM memory or the like).

User interface 910 includes an appropriate panel which allows a user to control the operation of the bedding system. In this regard, user interface may include various input regions (buttons, knobs, sliders, and the like), and output regions (LCD or LED displays, lights, lamps, etc.). The input regions may include, fore example, one or more of the following functions: on-off control, zone selection, increase temperature, decrease temperature, and timer control. The output regions on user interface 910 may include, for example, a zone-selection readout, a temperature readout, a temperature set-point readout, a timer readout, an on-off indicator, etc.

User interface may be included either on or separate from controller 110. In the event user interface is separate from controller 110, it may communicate with controller 110 via electrical wiring or, alternatively, a wireless device of the type used in connection with conventional remote controllers.

In accordance with another embodiment of the present invention, a multi-zone blanket comprises a first zone having a first insulation value and a second zone having a second insulation value, wherein the first insulation value is a function of a chemical reaction produced within the first zone of the blanket. The chemical reaction (e.g., an exothermic chemical reaction) may be produced through sudden or controllable mixing of one or more chemical components. In addition, the chemical reaction may be of the type which is responsive to an applied electrical excitation, in which case the user may be provided with an appropriate controller for modulating the rate of reaction and therefore the heating provided by that zone of the blanket.

In accordance with yet another embodiment of the present invention, a multi-zone blanket includes greater than two zones, wherein the individual zones are heated through application of an electrical current (e.g., through the use of heat-generating wires, pads, and the like). As described above in connection with the previous embodiments, a controller may be provided for controlling the heat and/or insulation value provided by the particular zones of the blanket. In addition, any convenient geometrical configuration may be provided for the various zones.

Although the invention has been described herein in conjunction with the appended drawings, those skilled in the art will appreciate that the scope of the invention is not so limited. Modifications in the selection, design, and arrangement of the various components and steps discussed herein may be made without departing from the scope of the invention as set forth in the appended claims.

What is claimed is:

1. A multi-zone bedding system comprising:
a blanket, said blanket comprising a first zone having a first insulation value and a second zone having a second insulation value;
a controller configured to modify said first insulation value of said first zone of said blanket substantially independently of said second insulation value of said second zone of said blanket.

2. The system of claim 1, wherein said controller is further configured to modify said second insulation value of said second zone of said blanket.

3. The system of claim 1, further comprising a sensor coupled to said controller, said sensor incorporated into said blanket for sensing a temperature of said first zone, said controller configured to modify said insulation value of said first zone in response to said temperature of said first zone.

4. The system of claim 3, further comprising a second sensor coupled to said controller, said second sensor incorporated into said blanket for sensing a temperature of said second zone, said controller configured to modify said insulation of said second zone in response to said temperature of said second zone.

5. The system of claim 1, further comprising an external sensor configured to sense an attribute of the environment of said blanket

6. The system of claim 5, wherein said external sensor is configured to sense an ambient temperature.

7. The system of claim 5, wherein said external sensor is configure to sense an intensity of ambient light.

8. The system of claim 1, wherein said controller further comprises a programmable timer and is further configured to modify said first insulation value in response to one or more timed events.

9. The system of claim 1, wherein said blanket has a shape selected from the group consisting of crib, day-bed, twin, twin extra long, super-single, full, queen, California-queen, king, and California-king.

10. The system of claim 1, wherein
said blanket includes a head end and a foot end opposite said head end; and
said first zone and said first zone are adjacent and extend substantially from said head end to said foot end of said blanket.

11. The system of claim 10, further including a transition zone between said first zone and said second zone, said transition zone configured to provide a transition insulation value which is less than that of said first zone and said second zone.

12. The system of claim 1, wherein said first zone of said blanket includes an inner chamber, and wherein said controller is configured to modify said first insulation value of said first zone by controlling the volume of air within said inner chamber.

13. The system of claim 12, wherein said controller includes an air pump.

14. The system of claim 1, wherein said first zone of said blanket includes a cellular structure whose thermal conductivity is a function of the volume of air contained within said cellular structure, and wherein said controller is configured to modify said first insulation value of said first zone by controlling said volume of air within said cellular structure.

15. The system of claim 1, wherein a thickness of said first zone remains substantially equal to a thickness of said second zone.

16. The system of claim 1, wherein said blanket further comprises an outer cover.

17. The system of claim 1, wherein said controller includes a memory configured to retain a preference corresponding to a desired insulation value of said first zone.

18. The system of claim 17, wherein said memory is further configured to retain a second preference corresponding to a desired insulation value of said second zone.

19. The system of claim 1, wherein said controller includes a memory configured to retain a plurality of preferences corresponding to a set of desired insulation values of said first zone, each of said plurality of preferences being associated with a time of day.

20. The system of claim 1, wherein said controller is further configured to learn a set of desired preferences corresponding to a set of desired insulation values based on an individual's operation of said controller.

21. A method for controlling a multi-zone bedding system, said method comprising the steps of:
providing a blanket including a first zone having a first insulation value and a second zone having a second insulation value;
modifying said first insulation value of said first zone of said blanket independently of said second insulation value of said second zone of said blanket.

22. The method of claim 21, further including the step of modifying said second insulation value of said second zone of said blanket.

23. The method of claim 21, further including the step of providing a sensor coupled to a controller, wherein said sensor is incorporated into said blanket for sensing a temperature of said first zone, further including the step of modifying said insulation value of said first zone in response to said temperature of said first zone.

24. The method of claim 23, further including the step of providing a second sensor coupled to said controller, wherein said second sensor is incorporated into said blanket for sensing a temperature of said second zone, further including the step of modifying said insulation value of said second zone in response to said temperature of said second zone.

25. The method of claim 21, further including the step of sensing an attribute of the environment of said blanket.

26. The method of claim 25, wherein said sensing step includes the step of sensing an ambient temperature.

27. The method of claim 25, wherein said sensing step includes the step of sensing an intensity of ambient light.

28. The method of claim 21, further including the step of modifying said first insulation value in response to one or more timed events.

29. The method of claim 21, wherein said step of providing a blanket includes the step of providing a blanket having a shape selected from the group consisting of crib, day-bed, twin, twin extra long, super-single, full, queen, California-queen, king, and California-king.

30. The method of claim 21, wherein said modifying step includes the step of modifying said first insulation value of said first zone by controlling the volume of air within an inner chamber provided within said blanket.

31. The method of claim 21, wherein said first zone of said blanket includes a cellular structure whose thermal conductivity is a function of the volume of air contained within said cellular structure, and wherein said modifying step includes the step of modifying said first insulation value of said first zone by controlling said volume of air within said cellular structure.

32. The method of claim 21, further including the step of maintaining a thickness of said first zone such that it is substantially equal to a thickness of said second zone.

33. The method of claim 21, further including the step of providing an outer cover for said blanket.

34. The method of claim 21, further including the step of retaining a preference corresponding to a desired insulation value of said first zone.

35. The method of claim 34, further including the step of retaining a second preference corresponding to a desired insulation value of said second zone.

36. The method of claim 21, further including the step of retaining a plurality of preferences corresponding to a set of desired insulation values of said first zone, wherein each of said plurality of preferences is associated with a time of day.

37. The method of claim 21, further including the step of learning a set of desired preferences corresponding to a set of desired insulation values based on an individual's operation of said blanket.

38. A multi-zone blanket comprising:
a first zone having a first insulation value;
a second zone having a second insulation value;
said first and second zone having first and second thicknesses, respectively, wherein said first and second thicknesses are substantially equal.

39. The multi-zone blanket of claim 38, wherein said first zone and said second zone comprise a first material having different densities.

40. The multi-zone blanket of claim 38, wherein said first zone and said second zone comprise different materials.

41. The multi-zone blanket of claim 38, wherein at least one of said first and second zones have insulation values controllable via the injection of air into said structure.

42. The multi-zone blanket of claim 38, wherein said blanket has a shape selected from the group consisting of crib, day-bed, twin, twin extra long, super-single, full, queen, California-queen, king, and California-king.

43. The system of claim 38, wherein:
said blanket includes a head end and a foot end opposite said head end; and
said first zone and said first zone are adjacent and extend substantially from said head end to said foot end of said blanket.

44. The system of claim 38, further including a transition zone between said first zone and said second zone, said transition zone configured to provide a transition insulation value which is less than that of said first zone and said second zone.

45. A multi-zone bedding system comprising:
a blanket, said blanket comprising a first zone having a first insulation value and a second zone having a second insulation value;
a controller configured to modify said first insulation value of said first zone of said blanket substantially independently of said second insulation value of said second zone of said blanket;
a sensor coupled to said controller, said sensor incorporated into said blanket for sensing a temperature of said first zone, said controller configured to modify said insulation value of said first zone in response to said temperature of said first zone; and
said first zone of said blanket having an inner chamber, wherein said controller further includes an air pump and is configured to modify said first insulation value of said first zone by controlling the volume of air within said inner chamber via said air pump.

46. A multi-zone blanket comprising:
a first zone having a first insulation value;
a second zone having a second insulation value;
wherein said first insulation value is a function of a chemical reaction produced within said first zone of said blanket.

47. The multi-zone blanket of claim 46, wherein said exothermic chemical reaction is responsive to an applied electrical excitation.

48. The system of claim 46, wherein said blanket has a shape selected from the group consisting of crib, day-bed, twin, twin extra long, super-single, full, queen, California-queen, king, and California-king.

49. The system of claim 46, wherein
said blanket includes a head end and a foot end opposite said head end; and
said first zone and said first zone are adjacent and extend substantially from said head end to said foot end of said blanket.

50. The system of claim 46, further including a transition zone between said first zone and said second zone, said transition zone configured to provide a transition insulation value which is less than that of said first zone and said second zone.

51. A multi-zone bedding system comprising:
a blanket, said blanket comprising a first zone having a first temperature, a second zone having a second temperature, and a third zone having a third temperature;
a controller configured to modify said first temperature of said first zone of said blanket substantially independently of said second and third temperatures through the use of an applied current.

52. The system of claim 51, wherein said blanket has a shape selected from the group consisting of crib, day-bed, twin, twin extra long, super-single, full, queen, California-queen, king, and California-king.

53. The system of claim 52, wherein
said blanket includes a head end and a foot end opposite said head end; and
said first zone and said first zone are adjacent and extend substantially from said head end to said foot end of said blanket.

54. The system of claim 52, further including a transition zone between said first zone and said second zone, said transition zone configured to provide a transition insulation value which is less than that of said first zone and said second zone.

55. The system of claim 52, wherein said first zone includes a conductive wire configured to generate heat in response to said applied current.
